(19) United States
(12) Patent Application Publication
(10) Pub. No.: US 2013/0176874 A1
(43) Pub. Date: Jul. 11, 2013

(54) UPLINK POWER/RATE SHAPING FOR ENHANCED INTERFERENCE COORDINATION AND CANCELLATION

(71) Applicant: QUALCOMM Incorporated, San Diego, CA (US)

(72) Inventors: Hao Xu, San Diego, CA (US); Madhavan Srinivasan Vajapeyam, San Diego, CA (US); Yongbin Wei, San Diego, CA (US)

(73) Assignee: QUALCOMM INCORPORATED, San Diego, CA (US)

(21) Appl. No.: 13/706,222

(22) Filed: Dec. 5, 2012

Related U.S. Application Data
(60) Provisional application No. 61/569,148, filed on Dec. 9, 2011.

(51) Int. Cl. H04W 52/24

(52) U.S. Cl. CPC H04W 52/24
USPC 370/252

(57) ABSTRACT

According to an aspect of the present disclosure, a serving base station determines a path loss and/or a distance measurement between the serving base station and a neighbor base station. A cell-specific power control parameter and a UE transmission power may be determined based on the determined path loss and/or distance measurement. Finally, the serving base station assigns a UE transmission rate based at least on a region where a UE is located, the region being within a serving cell

### CROSS-REFERENCE TO RELATED APPLICATION

This application claims the benefit under 35 U.S.C. §119(e) to U.S. Provisional Patent Application No. 61/569,148 entitled “UPLINK POWER/RATE SHAPING FOR ENHANCED INTERFERENCE COORDINATION AND CANCELLATION,” filed on Dec. 9, 2011, the disclosure of which is expressly incorporated by reference herein in its entirety.

### BACKGROUND

1. Field

Aspects of the present disclosure relate generally to wireless communication systems, and more particularly to uplink power and/or rate shaping.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### SUMMARY

According to an aspect of the present disclosure, a serving base station determines a path loss and/or a distance measurement between the serving base station and a neighbor base station. A cell-specific power control parameter and a UE transmission power may be determined based on the determined path loss and/or distance measurement. Finally, the serving base station assigns a UE transmission rate based at least on a region where a UE is located, the region being within a serving cell

In one configuration, a method of wireless communication includes determining, by a serving base station, a path loss and/or a distance measurement between the serving base station and a neighbor base station. The method also includes setting a UE transmission power based at least in part on the determining.

In another configuration, an apparatus for wireless communications includes means for determining, by a serving base station, a path loss and/or a distance measurement between the serving base station and a neighbor base station. The apparatus also includes means for setting a UE transmission power based at least in part on the determining.

According to yet another configuration, a computer program product for wireless communications includes a non-transitory computer-readable medium having program code recorded thereon. The program code includes program code to determine, by a serving base station, a path loss and/or a distance measurement between the serving base station and a neighbor base station. The program code further includes program code to set a UE transmission power based at least in part on the determining.

According to still yet another configuration, an apparatus for wireless communications includes a memory and a processor(s) coupled to the memory. The processor(s) is configured to determine, by a serving base station, a path loss and/or a distance measurement between the serving base station and a neighbor base station. The processor(s) is further configured to set a UE transmission power based at least in part on the determining.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of an access network.

FIG. 3 is a diagram illustrating an example of a downlink frame structure in

LTE.

FIG. 4 is a diagram illustrating an example of an uplink frame structure in

LTE.

FIG. 5 is a diagram illustrating an example of a radio protocol architecture for the user and control plane.

FIG. 6 is a diagram illustrating an example of an evolved Node B and user equipment in an access network.

FIG. 7 is a block diagram illustrating subframe partitioning in a heterogeneous network according to one aspect of the disclosure.

FIG. 8 is a diagram illustrating a range expanded cellular region in a heterogeneous network.

FIG. 9 is a block diagram conceptually illustrating an example of a wireless communication system.

FIGS. 10-12 are block diagrams illustrating methods for adaptively applying power and/or rate shaping according to aspects of the disclosure.

FIG. 13 is a conceptual data flow diagram illustrating the data flow between different modules/means/components in an exemplary apparatus.

FIG. 14 is a block diagram illustrating different modules/means/components in an exemplary apparatus.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

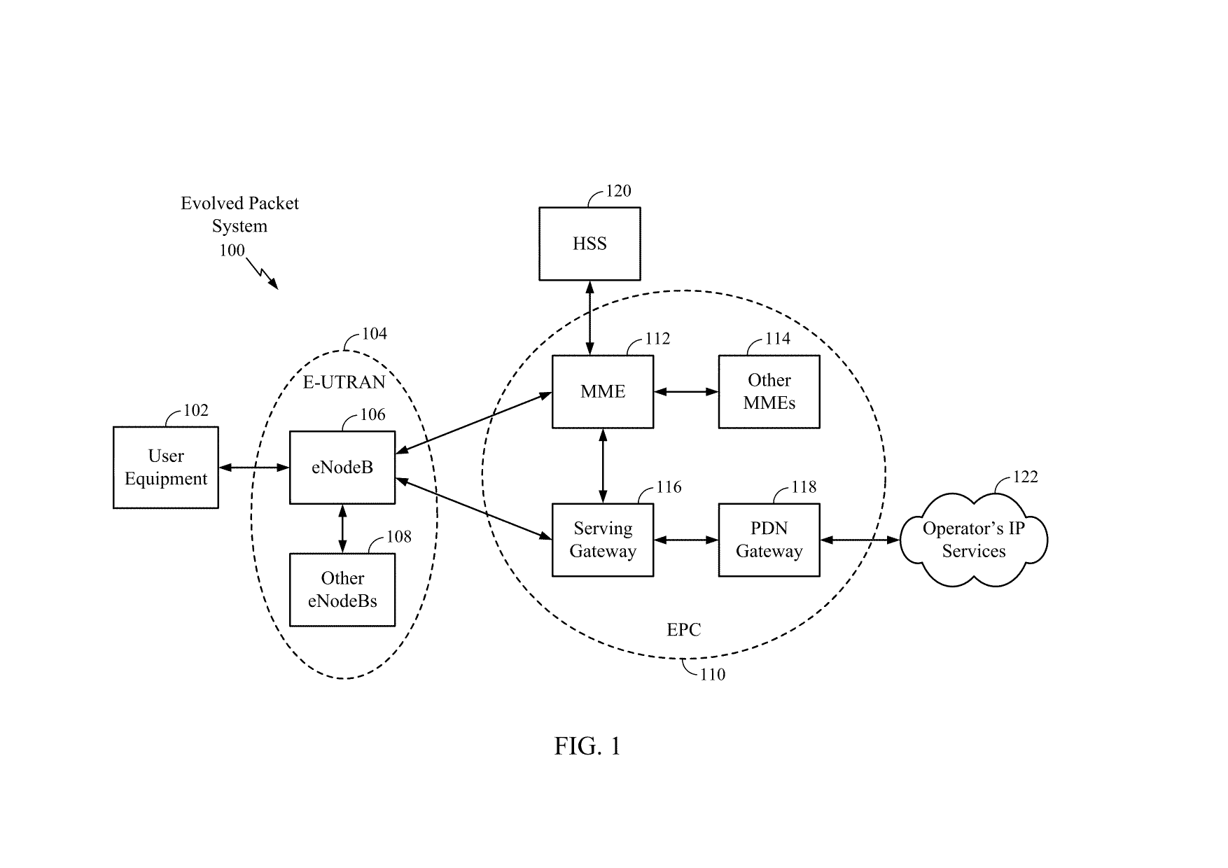

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

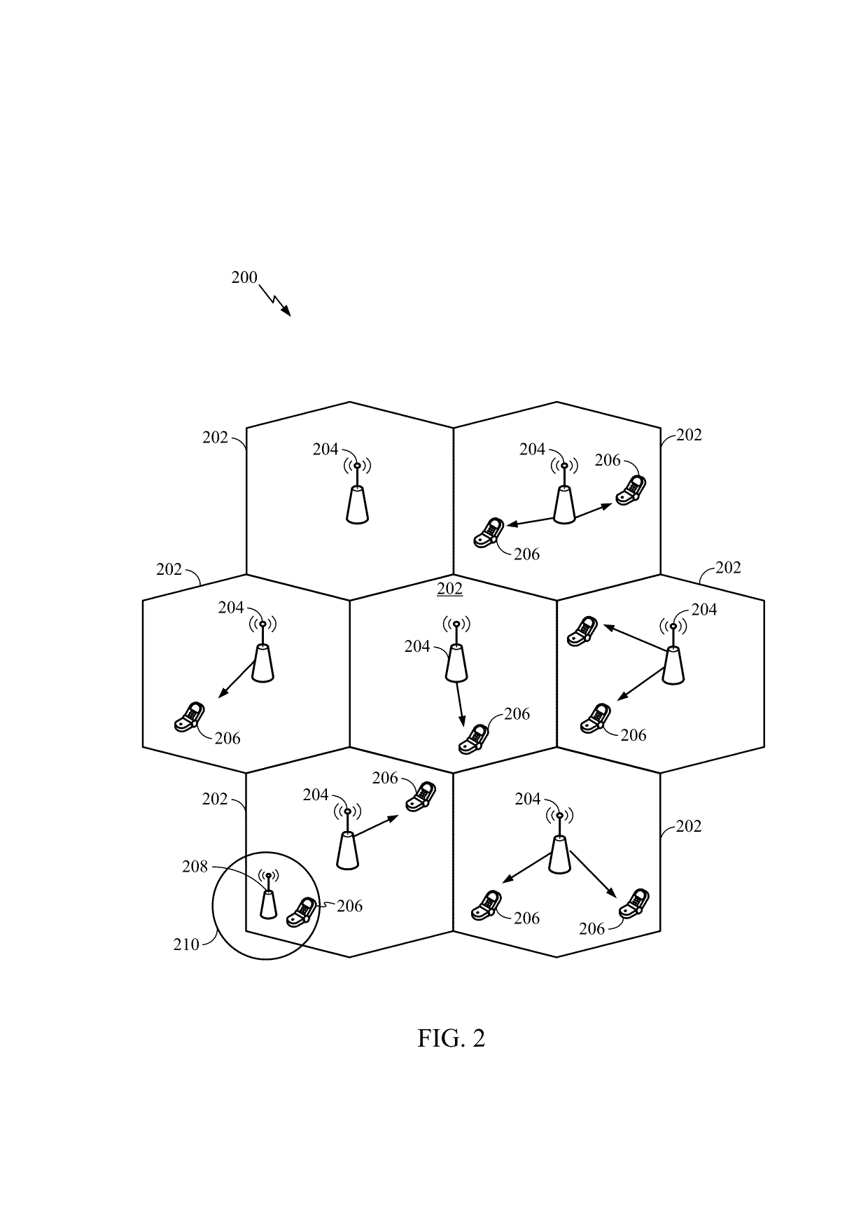

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. The lower power class eNodeB 208 may be a remote radio head (RRH), a femto cell (e.g., home eNodeB (HeNodeB)), pico cell, or micro cell. The macro eNodeBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the downlink and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. Orthogonal spacing between the subcarriers enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

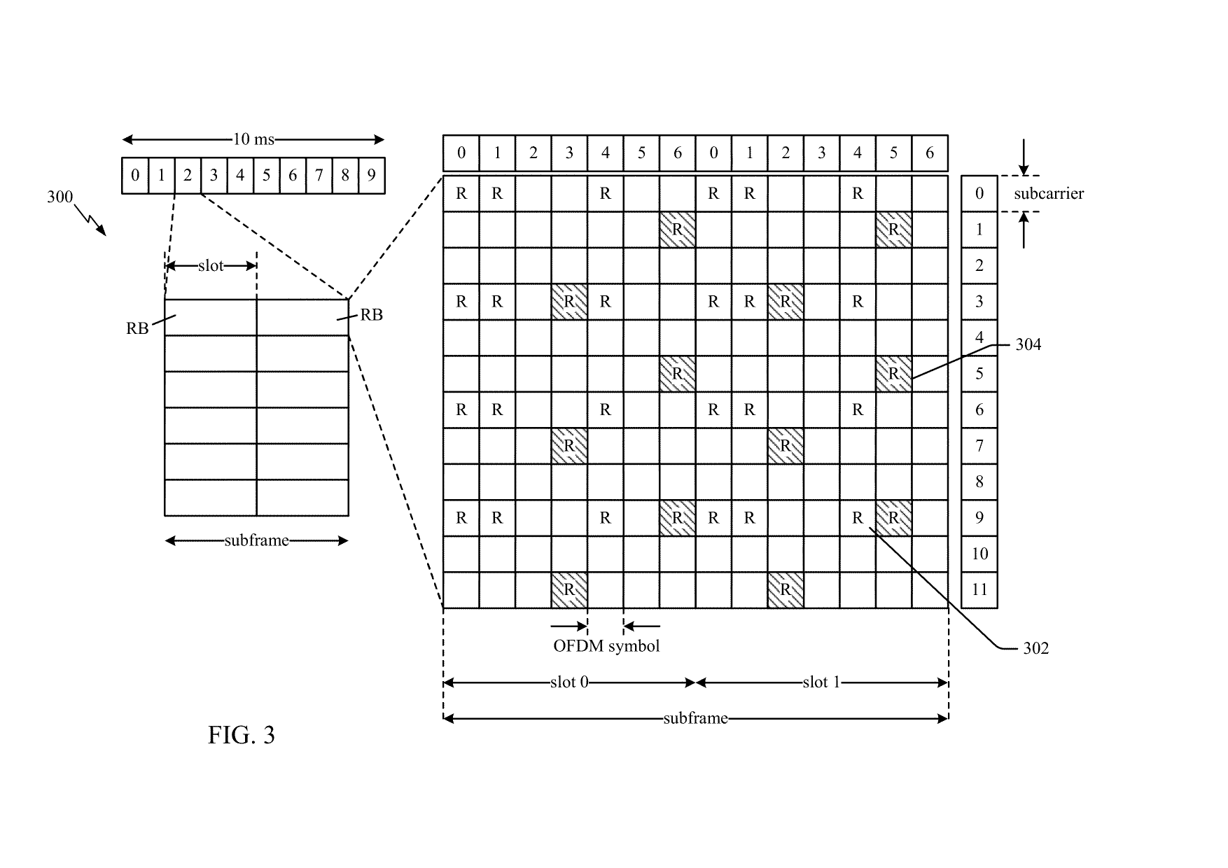

FIG. 3 is a diagram 300 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include downlink reference signals (DL-RS). The DL-RS include Cell-specific RS (CRS) (also sometimes called common RS) 302 and UE-specific RS (UE-RS) 304, but is not limited thereto. UE-RS 304 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

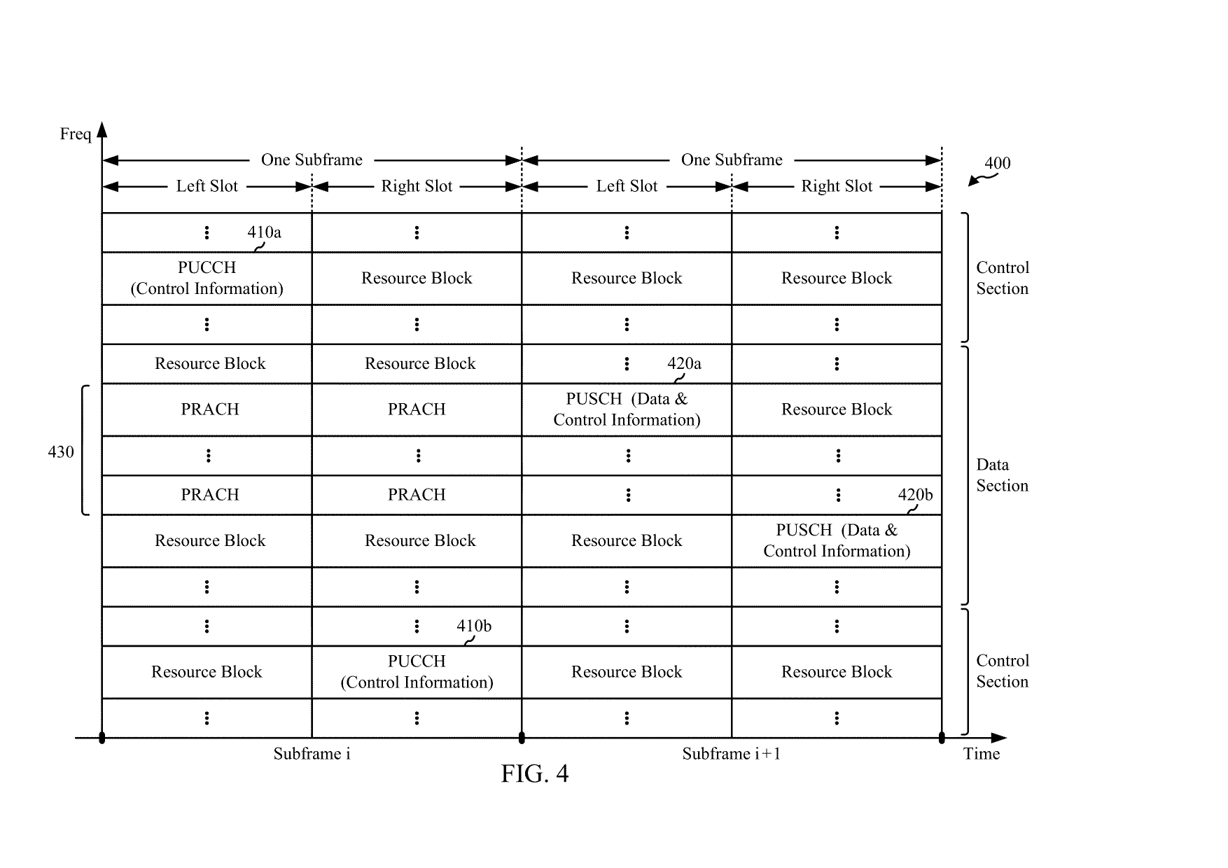

FIG. 4 is a diagram 400 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 410a, 410b in the control section to transmit control information to an eNodeB. The UE may also be assigned resource blocks 420a, 420b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 430. The PRACH 430 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

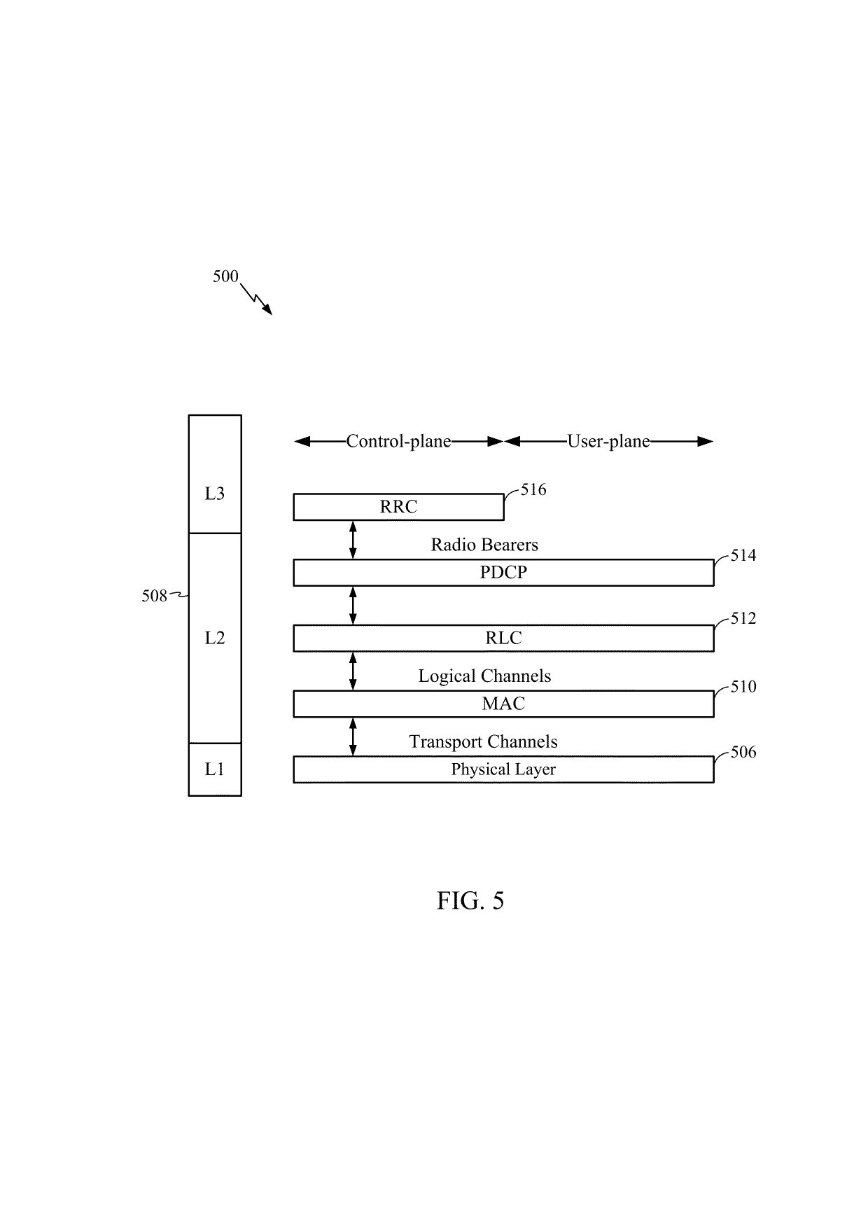

FIG. 5 is a diagram 500 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNodeB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNodeB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNodeBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNodeB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNodeB and the UE.

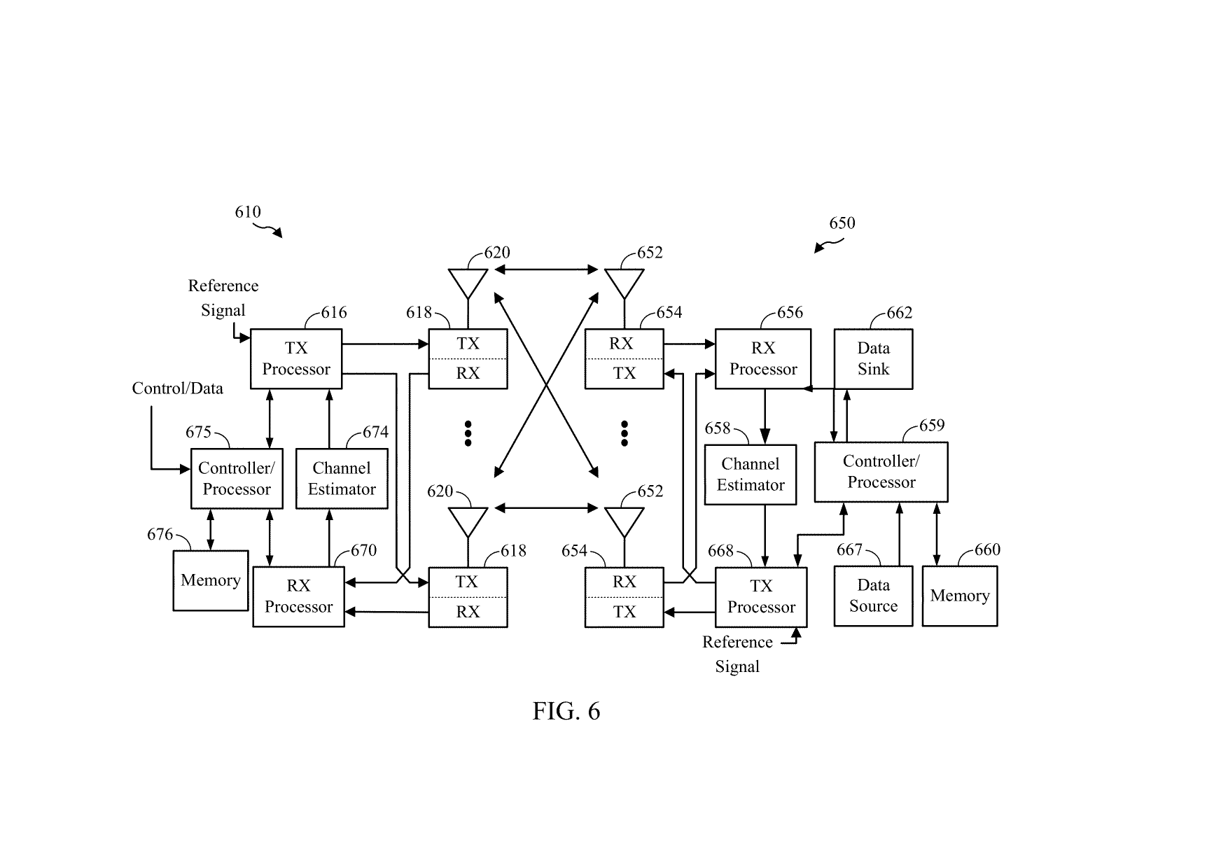

FIG. 6 is a block diagram of an eNodeB 610 in communication with a UE 650 in an access network. In the downlink, upper layer packets from the core network are provided to a controller/processor 675. The controller/processor 675 implements the functionality of the L2 layer. In the downlink, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNodeB 610. These soft decisions may be based on channel estimates computed by the channel estimator 658. The soft decisions are then decoded and deinterleaved to recover the data and control signals that were originally transmitted by the eNodeB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the uplink, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the uplink, a data source 667 is used to provide upper layer packets to the controller/processor 659. The data source 667 represents all protocol layers above the L2 layer. Similar to the functionality described in connection with the downlink transmission by the eNodeB 610, the controller/processor 659 implements the L2 layer for the user plane and the control plane by providing header compression, ciphering, packet segmentation and reordering, and multiplexing between logical and transport channels based on radio resource allocations by the eNodeB 610. The controller/processor 659 is also responsible for HARQ operations, retransmission of lost packets, and signaling to the eNodeB 610.

Channel estimates derived by a channel estimator 658 from a reference signal or feedback transmitted by the eNodeB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The uplink transmission is processed at the eNodeB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the uplink, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

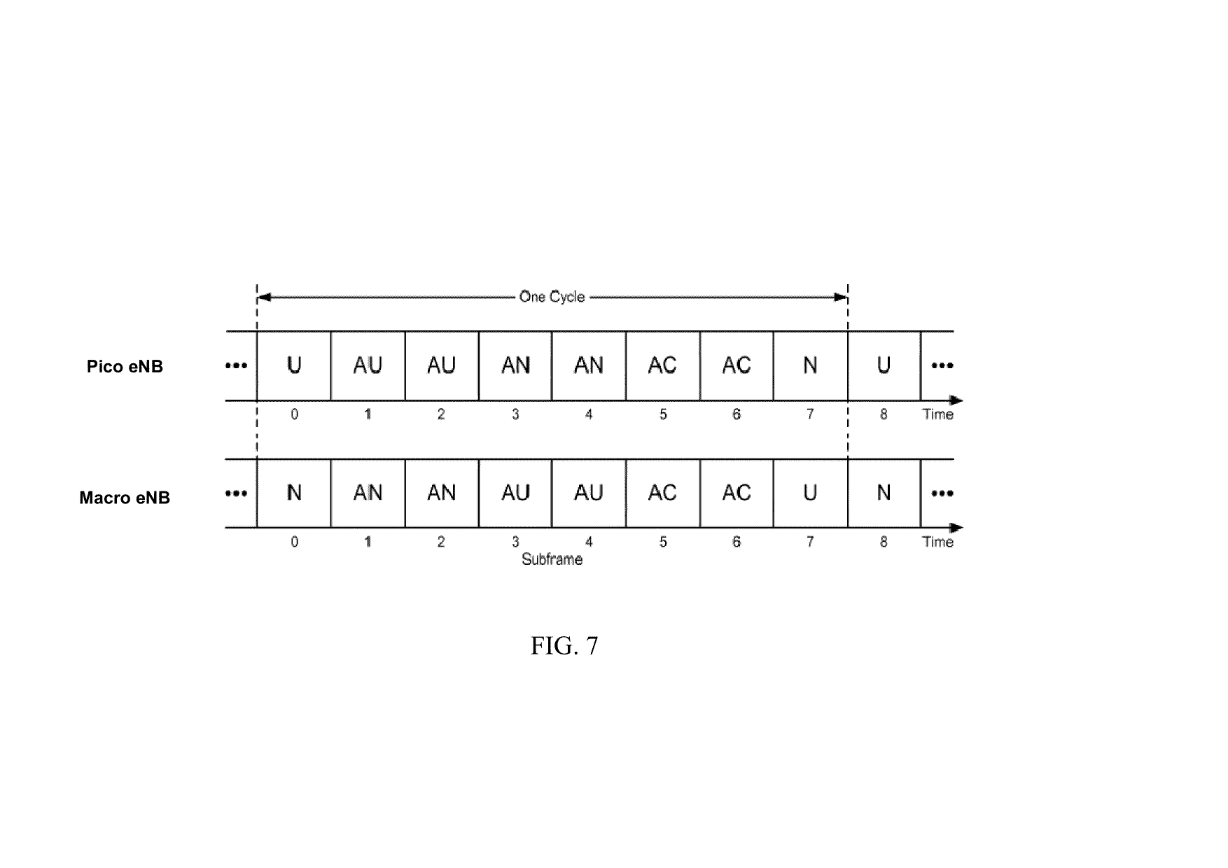

FIG. 7 is a block diagram illustrating subframe partitioning in a heterogeneous network according to one aspect of the disclosure. A first row of blocks illustrate subframe assignments for a low power node, such as a pico eNodeB, and a second row of blocks illustrate subframe assignments for a macro eNodeB. Each of the eNodeBs has a static protected subframe during which the other eNodeB has a static prohibited subframe. For example, the pico eNodeB has a protected subframe (U subframe) in subframe 0 corresponding to a prohibited subframe (N subframe) in subframe 0. Likewise, the macro eNodeB has a protected subframe (U subframe) in subframe 7 corresponding to a prohibited subframe (N subframe) in subframe 7. Subframes 1-6 are dynamically assigned as either protected subframes (AU), prohibited subframes (AN), and common subframes (AC). The dynamically assigned subframes (AU/AN/AC) are referred to herein collectively as “X” subframes. During the dynamically assigned common subframes (AC) in subframes 5 and 6, both the pico eNodeB and the macro eNodeB may transmit data.

Protected subframes (such as U/AU subframes) have reduced interference and a high channel quality because aggressor eNodeBs are prohibited from transmitting. Prohibited subframes (such as N/AN subframes) have no data transmission to allow victim eNodeBs to transmit data with low interference levels. Common subframes (such as C/AC subframes) have a channel quality dependent on the number of neighbor eNodeBs transmitting data. For example, if neighbor eNodeBs are transmitting data on the common subframes, the channel quality of the common subframes may be lower than the protected subframes. Channel quality on common subframes may also be lower for cell range expansion area (CRE) UEs strongly affected by aggressor eNodeBs. An CRE UE may belong to a first eNodeB but also be located in the coverage area of a second eNodeB. For example, a UE communicating with a macro eNodeB that is near the range limit of a pico eNodeB coverage is an CRE UE.

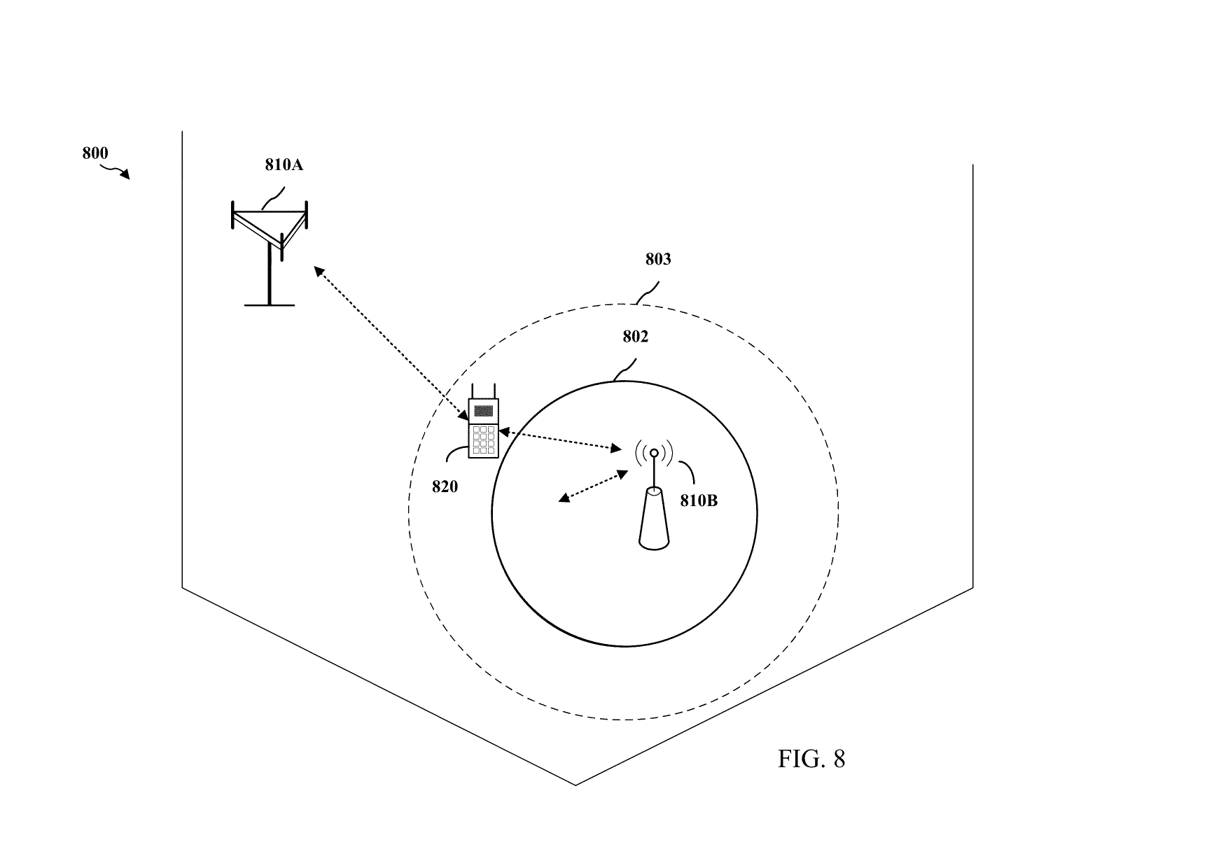

FIG. 8 is a diagram illustrating a range expanded cellular region in a heterogeneous network 800. A lower power class eNodeB such as the pico cell 810B may have a range expanded cellular region 803 that is expanded from the cellular region 802 through enhanced inter-cell interference coordination between the pico cell 810B and the macro eNodeB 810A and through interference cancelation performed by the UE 820. In enhanced inter-cell interference coordination, the pico cell 810B receives information from the macro eNodeB 810A regarding an interference condition of the UE 820. The information allows the pico cell 810B to serve the UE 820 in the range expanded cellular region 803 and to accept a handoff of the UE 820 from the macro eNodeB 810A as the UE 820 enters the range expanded cellular region 803.

Uplink Power Control and Rate Shaping

In a heterogeneous network, different nodes may transmit at different power levels, for example a macro cell may transmit at a power that is greater than a power of low power node (e.g., a pico cell or femto cell). Furthermore, a UE may be associated with either a high power node or a low power node. Because the UE may be associated with nodes having different power levels, the network may potentially experience interference on an uplink.

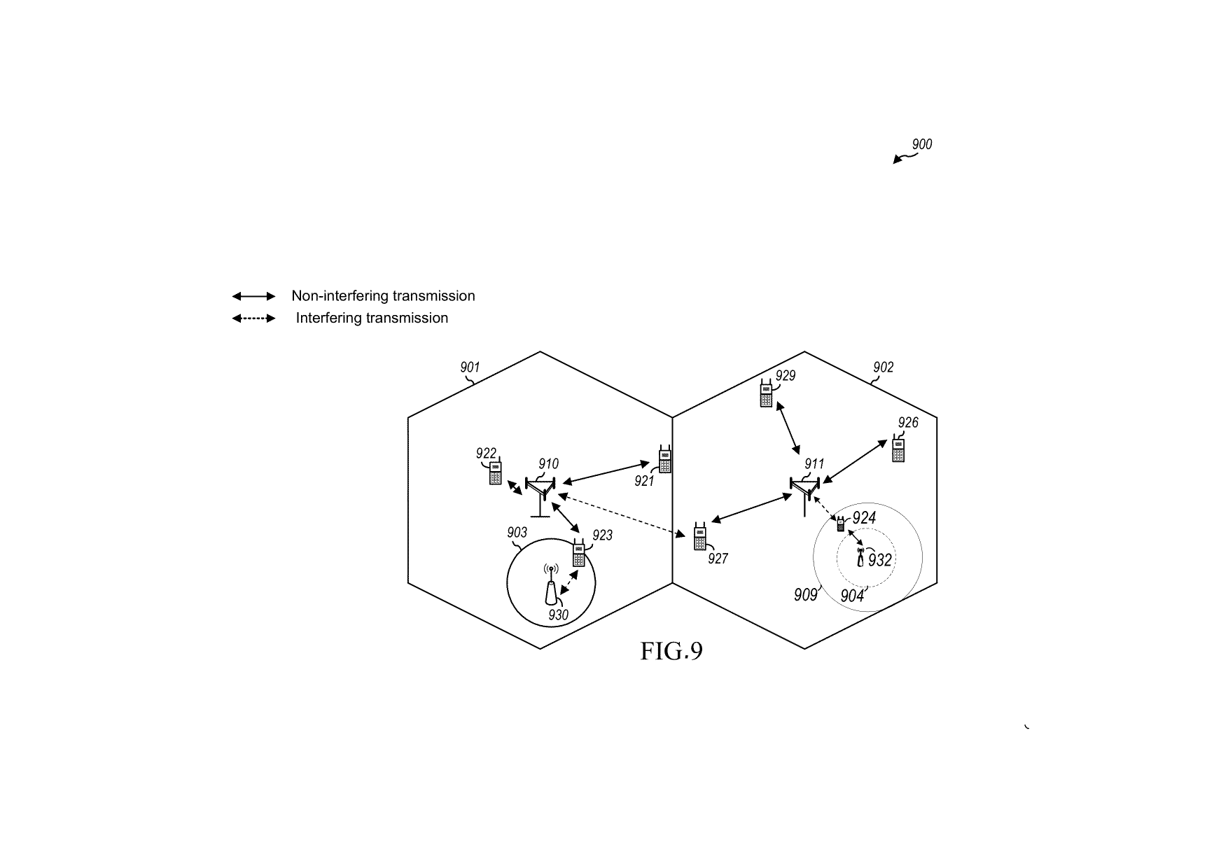

FIG. 9 illustrates a heterogeneous wireless network 900 having macro cells 901, 902 served by macro base stations 910, 911 and pico cells 903, 904 served by pico base stations 930, 932. The pico base stations 930, 932 are overlaid within the coverage areas of the macro cells 901, 902. UEs 921, 922, 923, 924, 926, 927, and 929 may be located within the coverage are of the macro cells 901, 902. Furthermore, the UE 923 may also be within the coverage area of the pico cell 903. Additionally, the UE 924 may be within an expanded coverage area of the pico cell 909. Finally, as shown in FIG. 9, some of the transmissions between specific UEs 921, 922, 923, 924, 926, 927, and 929 and base stations 930, 932, 910, and 911 may be non-interfering transmissions (solid line) and other transmissions between specific UEs 921, 922, 923, 924, 926, 927, and 929 and base stations 930, 932, 910, and 911 may be interfering transmissions (dashed line).

In the heterogeneous wireless network 900, power shaping and rate shaping are specified by adjusting a power control parameter in a power control formula. The power control parameter may be signaled on a per cell basis and is related to path loss (also referred to as a path loss compensation parameter). When the value of the power control parameter is less than one, a user located at the edge of the coverage area of the macro cell 901 (e.g., UE 921) transmits with less power, while a user in the center of the coverage area of the macro cell 901 (e.g., UE 922) transmits with greater power. Thus, the macro base station 910 may power shape the users by adjusting the value of the power control parameter.

Additionally, the macro base station 910 may use rate control to perform link adaptation. In some cases, the value of the power control parameter may be set to one, in which case the macro base station 910 may use closed loop power control to maintain link adaptation. That is, the macro base station 910 uses closed loop power control instead of path loss compensation power control. The power control parameter may be referred to as alpha.

As discussed above, various interference conditions may be present in a heterogeneous network. For example, the heterogeneous wireless network 900 may include low power nodes (e.g., pico base stations 930, 932) within the coverage area of macro cells 901, 902. Due to the downlink transmit power difference, a UE 923 may associate with the macro base station 910 even if the UE 923 is in closer proximity to the pico base station 930. In this example, the UE 923 may transmit with a greater power because the UE 923 is not in close proximity to the macro base station 910. By transmitting with a greater power, the UE 923 may cause interference for the pico cell 903 on uplink transmissions. As another example, if the pico base station 930 is a closed subscriber group (CSG) base station, the UE 923 associated with the macro cell 901 may create power racing conditions in the uplink transmissions between the closed subscriber group UEs and macro UEs, since interference from UE 923 may cause the CSG UEs to increase their transmit power, which in turn will cause UE 923 to increase its transmit power. Specifically, both UEs continue to power up and create further interference to each other.

In some cases, range expansion techniques may enhance capacity by associating more users with the pico cell. For example, in FIG. 9, the heterogeneous wireless network 900 supports cell range expansion and the coverage of the pico base station 932 may be expanded from baseline coverage area of the pico cell 904 to an expanded coverage area of the pico cell 909. In some cases, the UE 924 may be associated with the pico base station 932 and may cause uplink interference for the macro cell 902.

In some conventional systems, such as CDMA, interference may only be mitigated via power control. According to an aspect of the present disclosure, to mitigate potential interference, rate control is specified for uplink adaptation instead of, or in addition to, power control for data channel transmissions. That is, when the uplink is suffering from interference, the uplink rate may be adjusted to mitigate the interference. For example, in a conventional system, when a UE is experiencing interference, the UE may only increase its power to mitigate the interference. However, in this aspect of the disclosure, when the UE is experiencing interference, the network, may instruct the interferer and/or the UE to transmit at a lower rate to mitigate the interference. In one configuration, the transmission rate may be adjusted via a cell-specific power control parameter. Rate control may also be improved by using HARQ gains, for example, targeting later terminations.

Specifically, the transmission rate adjustments may compensate for the power rate limit specified for UEs, such as UEs on the edge of a cell. That is, for example, a UEs ability to increase transmission power to overcome interference may be limited due to the UEs location within a serving cell. Therefore, based on the location of the UE within the serving cell, the interference may be mitigated by adjusting the UE's transmission rate or the interferer's transmission rate. The transmission rate may be adjusted based on the cell-specific power control parameter.

The cell-specific power shaping may overcome the path loss for some users and partially overcome the path loss for other users. For example, the path loss from the base station may be 100 dB. When the power control parameter is set to one, the UE is specified to overcome all of the path loss (100 dB) and has an increased transmission power. Still, if the power control parameter is set to less than one, the UE may overcome some of the path loss with a decreased transmission power. For example, if the power control parameter is set to 0.9, then the UE is specified to overcome ninety percent of the path loss (e.g., 90 dB) and may thus have a decreased transmission power. The decreased transmission power may mitigate the potential interference. In alternative embodiments, the control transmission parameter may be an indexed value, or a value corresponding to logarithmic or exponential changes.

For example, for users in a pico cell, open loop path loss compensation based power shaping may control cell edge UEs to transmit with less power. Specifically, the power control parameter may be set at a specific value, such as less than one, so the UEs on the edge will transmit at a decreased power level to mitigate potential interference with UEs of a neighboring cell, such as a macro cell. According to this aspect, rate control may also be applied to the UEs after specifying the power shaping.

Optionally, in another aspect, inter-cell interference may be managed through interference over thermal (IoT) monitoring and overload indication based solutions. Specifically, a UE or base station may transmit a signal indicating that interference is being experienced and the other UEs or cells may specify solutions for mitigating the interference.

According to yet another aspect, when an interferer is detected, adaptive noise padding for the physical uplink shared channel (PUSCH) may be specified for a cell, such as a pico cell, to increase its noise level. The noise padding increases the effective path loss to the interfering UE.

In still another aspect of the present disclosure, adaptive power shaping may be applied to specific cells, such as low power nodes. While low power nodes are referred to as pico cells in the present disclosure, the low power nodes referred to are not limited to the low power nodes and may contemplate other low power nodes, such as remote radio heads (RRHs), femto cells, micro cells, etc. The cell-specific power-shaping enables UEs in a pico cell to obtain better coverage without injecting high interference to the macro cells. Specifically, a UE at or near the center of the cell may transmit at a high power and UEs at or near the edge of the cell may be power shaped.

In one configuration, a cell-specific power control parameter is selected to enable rate shaping on a cell by cell basis. A value for the cell-specific power control parameter is selected based on path loss and/or a distance measurement between cells. A pico cell selects the value of the cell-specific power control parameter based on the measured path loss from the macro cell to the pico cell. The measured path loss may be an implicit indicator of the distance from the macro cell. The pico cell may also select the cell-specific power control parameter based on the actual distance from the macro cell to the pico cell. In some cases, the cell-specific power control parameters may not vary based on the number of UEs served or UE mobility. Moreover, the cell-specific power control parameters do not rely on UE reported measurements. That is, the cell-specific power control parameter may not rely on UE-specific radio conditions and the cell-specific power control parameter may apply to all UEs in the specific cell. The cell-specific power control parameter may be referred to as a cell-specific power control transmission parameter.

If the cell-specific power control parameter is selected based on an explicit distance measurement, the pico cell can obtain the distance to other macro cells via a distance measurement device, such as a GPS device. Additionally, the path loss and/or reference signal receive power (RSRP) measurements can be obtained in a network listening mode. Specifically, the pico cell may listen to signals from the macro cell to estimate distance.

In one configuration, the cell-specific power control parameter may be selected or further determined based on base station signaling. In particular, if a cell, (e.g. macro cell), is experiencing high interference (e.g., high interference over thermal (IoT)), the macro base station may signal a suggested power shaping parameter(s) to pico base stations. For example, the macro base station can signal pico base stations to set the cell-specific power control parameter to a value that is less than or equal to the power control parameter of the macro to reduce the amount of interference the macro base station will experience from the other low power nodes. For example, 0.8 may be a typical value for a macro's power control parameter. Additionally, the macro base station may signal (e.g., broadcast) its own power control parameter value (e.g., neighbor power control parameter), so other cells know how aggressively the macro base station is power controlling transmissions of UEs in the macro cell. The pico base stations can then adjust their power accordingly. The signaling can be carried via an X2 interface, a fiber connection in remote radio heads (RRH), or operations, administration, and maintenance (OAM) configuration.

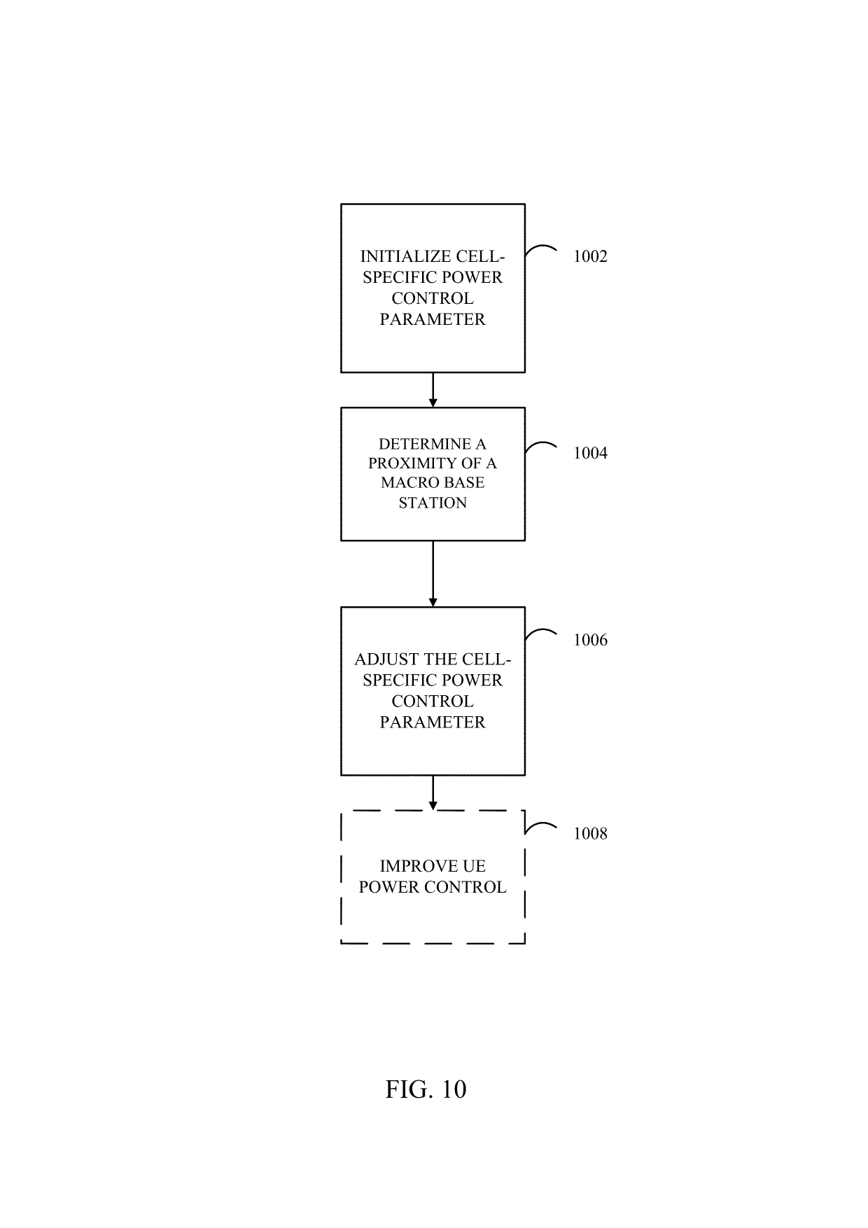

FIG. 10 illustrates a path loss based cell-specific power control parameter selection according to an aspect of the present disclosure. At block 1002, the cell-specific power control parameter is initialized for all pico cells (e.g., pico cell 903). For example, the cell-specific power control parameter may be the same as the power control parameter of the macro cell (e.g., 0.8). The pico cell may be informed of the alpha value of the macro cell based on backhaul messaging or other communication channels.

At block 1004, each pico base station determines proximity of neighbor macro base stations. Specifically, the pico base station may determine the nearest macro base station, M1, based on a path loss (PL) measurement. The distance to the macro base station may be implied via the path loss measurement. In another configuration, each pico base station determines the nearest macro base station, M1, based on an explicit distance measurement of the pico base station from the macro base stations(s). The distance can be measured via a distance measurement device, such as GPS device.

At block 1006, the cell-specific power control parameter is adjusted based on the distance to the macro base station. Specifically, the cell-specific power control parameter is increased if the path loss is determined to exceed a first path loss threshold. Alternately, the cell-specific power control parameter is decreased if the path loss is determined to be less than a second path loss threshold. In the case of distance measurement, the UE of the pico cell may transmit at an increased power without affecting the UEs of the macro cell and the value of alpha is increased if the distance of the pico is greater than a first distance threshold. Furthermore, the value of the cell-specific power control parameter is decreased if the distance from the pico is less than a second threshold value.

Optionally, at block 1008, UE-specific power control may be improved by adjusting a UE-specific power control parameter if the macro base station that is closest to the UE is not M1 (block 1004). That is, the value of the UE-specific power control parameter may be adjusted if the macro base station determined to be the nearest macro cell to the UE is not the nearest to the pico cell (i.e., the pico cell is in between two macro cells). For example, the UE-specific power control parameter may be increased or decreased according to the cell-specific power control parameter or a baseline value. In particular, the UE's power spectral density (PSD) may be adjusted via intra-cell power control commands to reduce the interference to the macro cell. The UE-specific power control parameter is adjusted depending on which macro cell is being interfered with. In this case, the distance to both macro cells is considered to select the power control parameter. That is, if only a specific UE is interfering with the other cell, the eNodeB may directly reduce power for the specific UE via the power control command, instead of adjusting the cell-specific power control parameter of the entire cell.

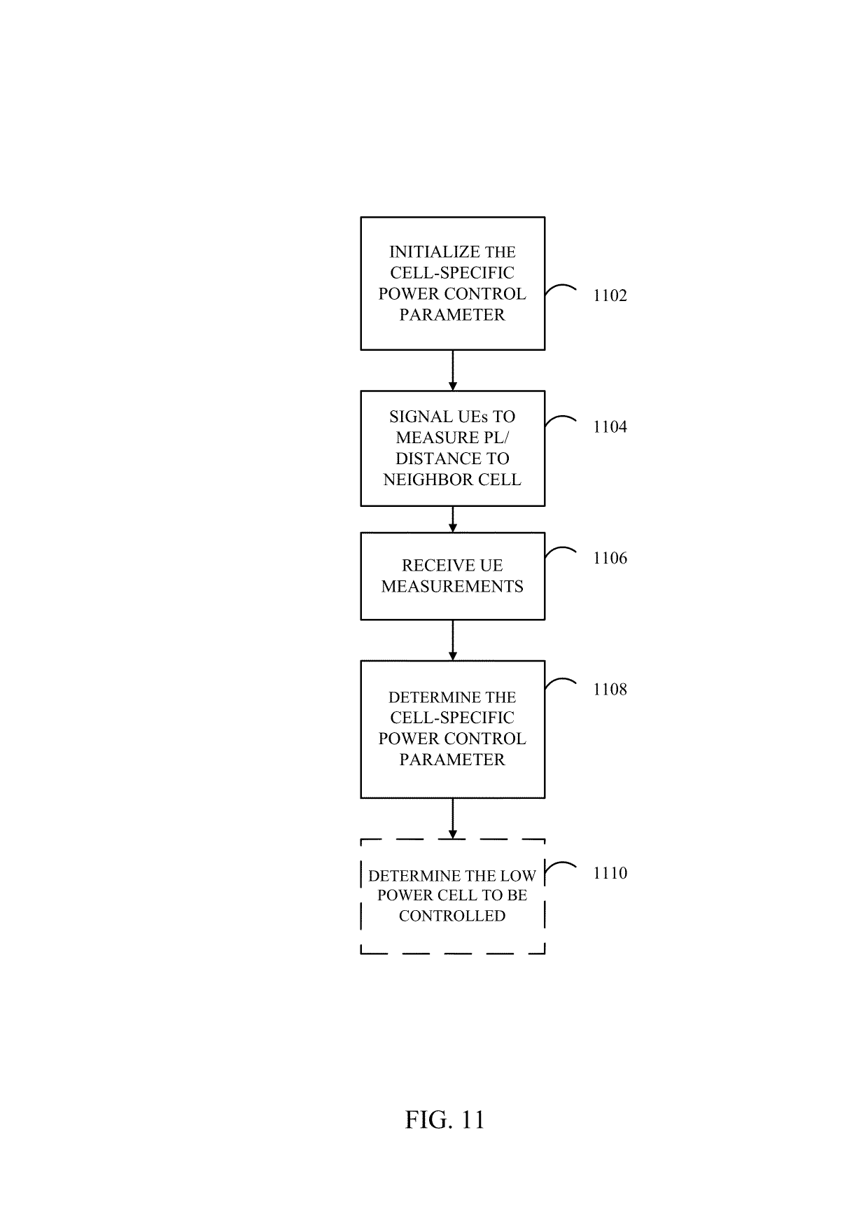

In another aspect, the cell-specific power control parameter selection is enhanced via UE measurements, instead of base station measurements. Referring to FIG. 11, at block 1102, the cell-specific power control parameter is initialized for all pico cells. For example, the cell-specific power control parameter may be set to 0.8, the same as the macro cell. At block 1104, a UE operating within the region of a pico cell is requested to measure path loss or distance from a neighbor cell and reports the measurement to the serving cell (e.g., pico cell). In one configuration, the path loss or distance measurement is performed by all UEs within the region of the cell. In another configuration, only the UEs in the range extension area are instructed to provide measurements. In yet another configuration, all UEs outside the range extension area are signaled to provide measurements.

At block 1106, the serving cell receives the measurement(s) from the signaled UE(s). At block 1108, the serving cell determines the cell-specific power control parameter based on the reported path loss/distance from the UEs. Optionally, at block 1110, the serving cell can use the information from the UE reporting the smallest path loss/distance (e.g., the UE closest to a neighbor cell) to determine which low power cell to be controlled. To determine the actual cell-specific power control parameter values, the previously provided examples may be applied.

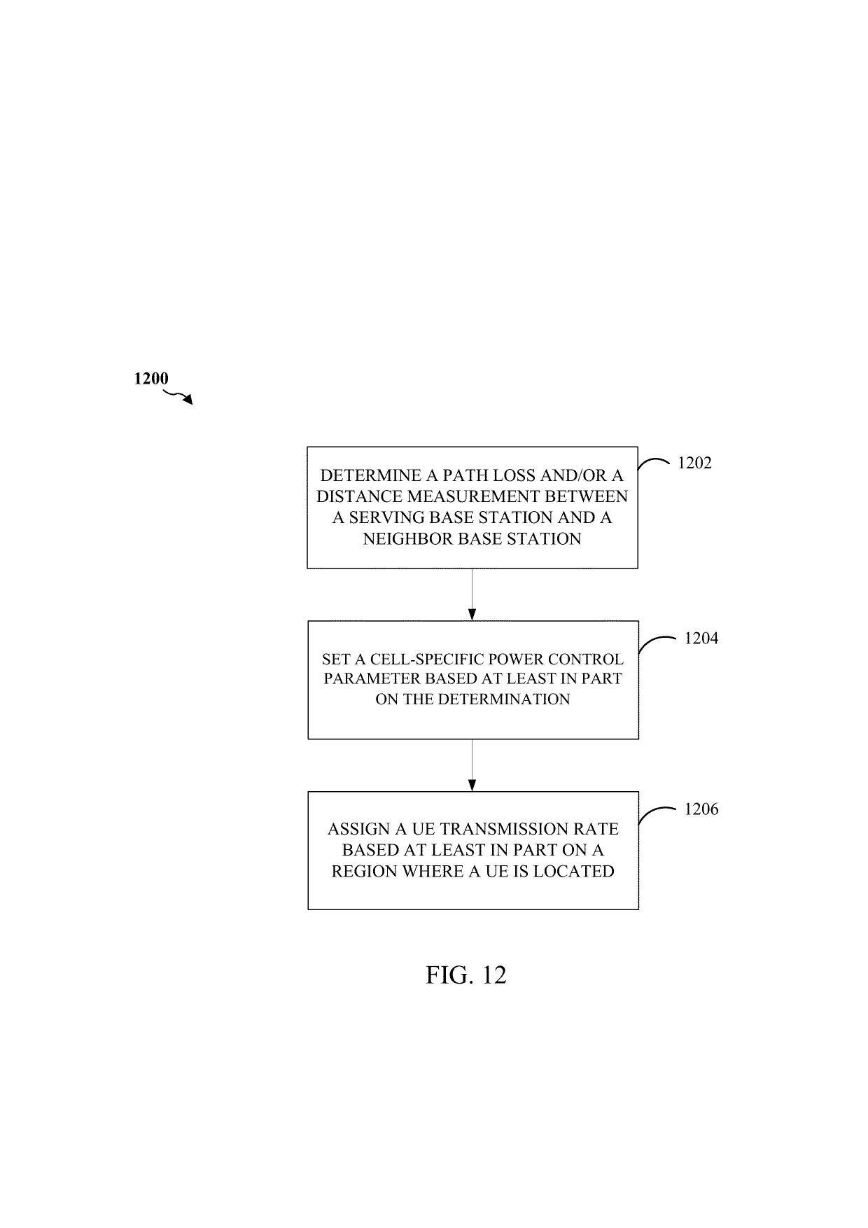

FIG. 12 illustrates a method 1200 for uplink power control and rate shaping. In block 1202, a base station determines a path loss and/or a distance measurement between a serving base station and a neighbor base station. A pico cell selects the value of the cell-specific power control parameter based on the measured path loss from the macro cell to the pico cell. The measured path loss may be an implicit indicator of the distance from the macro cell. In one configuration, the cell-specific power control parameter may be selected based on an explicit distance measurement. That is, pico cell can obtain the distance to other macro cells. Additionally, the path loss and/or reference signal receive power (RSRP) measurements can be obtained in a network listening mode. Specifically, the pico cell may listens to signals from the macro cell.

The base station sets a cell-specific power control parameter based at least in part on the determination in block 1204. In some cases, the base station may increase the cell-specific power control parameter from an initial value when the distance or path loss is greater than a threshold. Alternatively, the base station may decrease the cell-specific power control parameter from an initial value when the distance or path loss is less than a threshold.

In block 1206, the base station assigns a transmission rate for each UE based at least in part on the location of the UE within the serving cell. As an example, the base station may decrease the transmission rate of a UE if the UE is causing uplink interference on an edge of the serving cell. The transmission rate may also be based on the cell-specific power control parameter and/or the UE transmission power.

Aspects of the present disclosure have been described for macro cells and pico cells. Still, the aspects are not limited to macro cells and pico cells, the aspects are also contemplated for other types of cells and base stations.

In one configuration, the eNodeB 610 is configured for wireless communication including means for determining. In one aspect, the determining means may be the controller/processor 675, receive processor 670, and memory 646 configured to perform the functions recited by the determining means. The eNodeB 610 is also configured to include a means for setting. In one aspect, the setting means may be the controller/processor 675, transmit processor 616, modulators 618 and antenna 620 configured to perform the functions recited by the setting means. In another aspect, the aforementioned means may be any module or any apparatus configured to perform the functions recited by the aforementioned means.

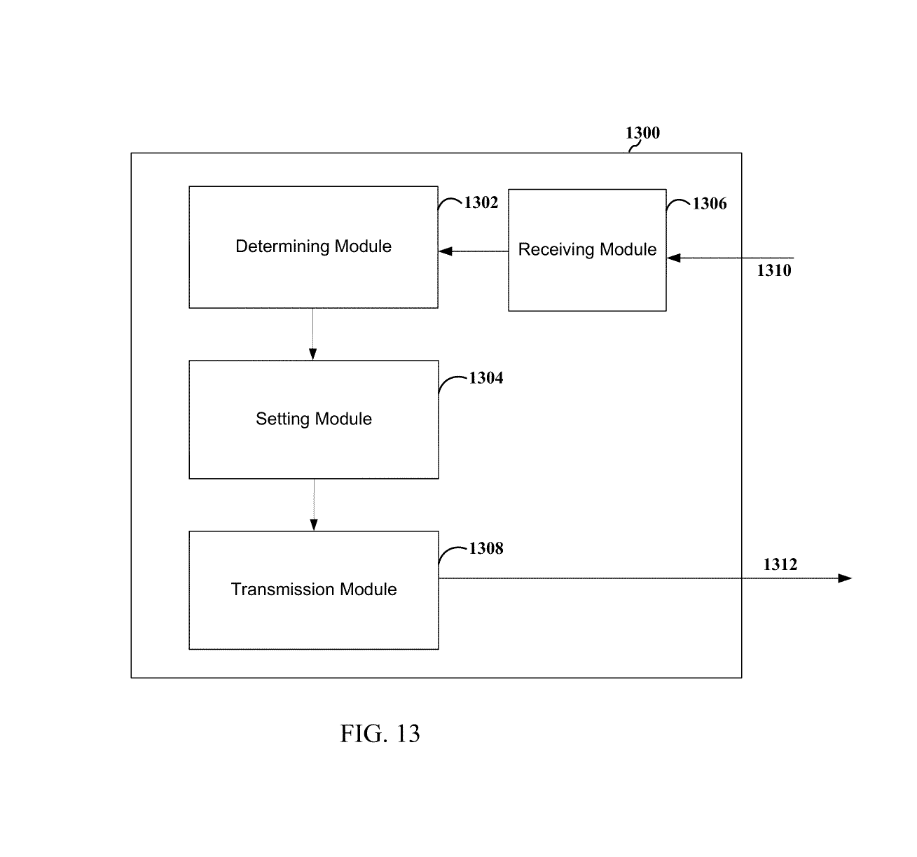

FIG. 13 is a conceptual data flow diagram illustrating the data flow between different modules/means/components in an exemplary apparatus 1300. The apparatus 1300 includes a determining module 1302 that determines, by a serving base station, a path loss and/or a distance measurement between the serving base station and a neighbor base station. The determining module 1302 may also determine a cell-specific power control parameter based at least in part on the path loss and/or the distance measurement. The determining module determines the path loss and/or a distance measurement based on a signal 1310 received by the receiving module 1306. The receiving module 1306 may transmit the received signal 1310 to the determining module 1302.

The apparatus 1300 also includes a setting module 1304 that sets a UE transmission power based at least in part on the determining. The setting module 1304 may also assign a UE transmission rate based at least on a region where a UE is located, the region being within a serving cell. The setting module sets the UE transmission power and/or assigns the UE transmission rate based on the determining performed by the determining module 1302. The UE transmission power and/or UE transmission rate may be signaled via a signal 1312 transmitted by the transmission module 1308. The transmission module 1308 may receive the signals 1312 to transmit from the setting module 1304. The apparatus may include additional modules that perform each of the steps of the algorithm in the aforementioned flow charts FIG. 12. As such, each step in the aforementioned flow charts FIG. 12 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

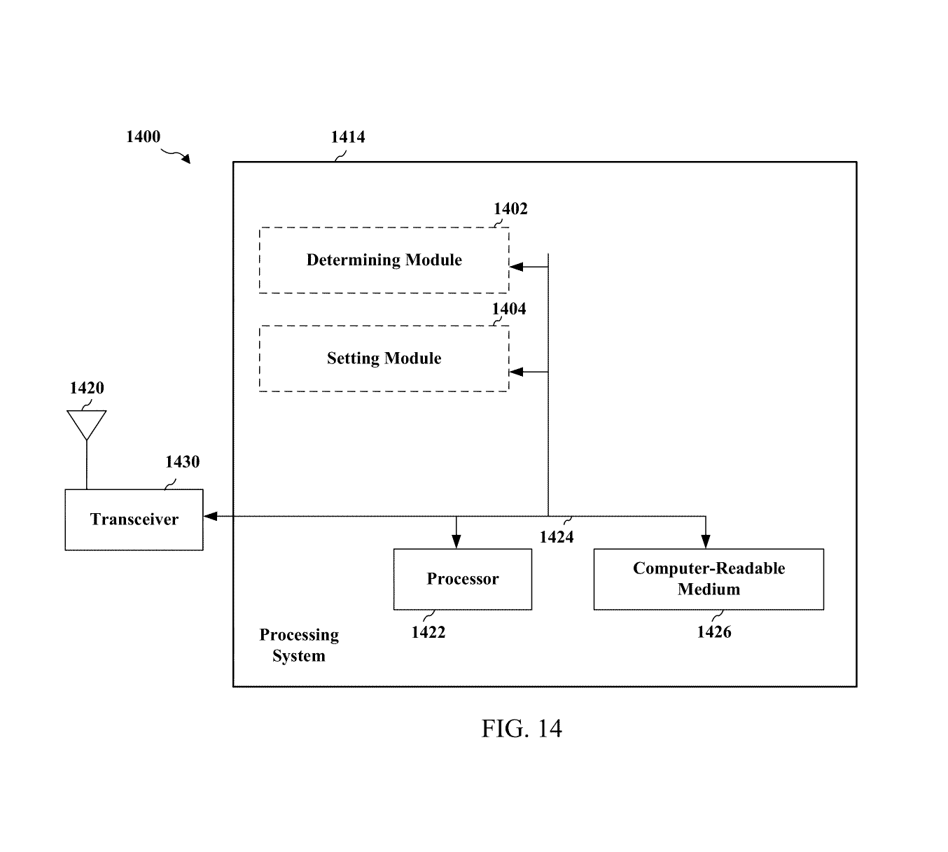

FIG. 14 is a diagram illustrating an example of a hardware implementation for an apparatus 1400 employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1422 the modules 1402, 1404, and the computer-readable medium 1426. The bus 1424 may also link various other circuits such as timing sources, peripherals, voltage regulators, and power management circuits, which are well known in the art, and therefore, will not be described any further.

The apparatus includes a processing system 1414 coupled to a transceiver 1430. The transceiver 1430 is coupled to one or more antennas 1420. The transceiver 1430 enables communicating with various other apparatus over a transmission medium. The processing system 1414 includes a processor 1422 coupled to a computer-readable medium 1426. The processor 1422 is responsible for general processing, including the execution of software stored on the computer-readable medium 1426. The software, when executed by the processor 1422, causes the processing system 1414 to perform the various functions described for any particular apparatus. The computer-readable medium 1426 may also be used for storing data that is manipulated by the processor 1422 when executing software.

The processing system 1414 includes a determining module 1402 for determining, by a serving base station, a path loss and/or a distance measurement between the serving base station and a neighbor base station. The determining module 1402 may also determine a cell-specific power control parameter based at least in part on the path loss and/or the distance measurement. The processing system 1414 also includes a setting module 1404 for setting a UE transmission power based at least in part on the determining. The setting module 1304 may also assign a UE transmission rate based at least on a region where a UE is located, the region being within a serving cell. The modules may be software modules running in the processor 1422, resident/stored in the computer-readable medium 1426, one or more hardware modules coupled to the processor 1422, or some combination thereof. The processing system 1414 may be a component of the UE 650 and may include the memory 660, and/or the controller/processor 659.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
determining, by a serving base station, a path loss and/or a distance measurement between the serving base station and a neighbor base station; and
setting a UE transmission power based at least in part on the determining.

2. The method of claim 1, further comprising:
determining a cell-specific power control parameter based at least in part on the path loss and/or the distance measurement; and
assigning a UE transmission rate based at least on a region where a UE is located, the region being within a serving cell.

3. The method of claim 2, in which the determining comprises:
increasing the cell-specific power control parameter from a baseline value when the path loss and/or the distance measurement is greater than a threshold; and
decreasing the cell-specific power control parameter from the baseline value when the path loss and/or the distance measurement is less than the threshold.

4. The method of claim 2, further comprising receiving from the neighbor base station a neighbor base station power control parameter and/or a serving base station power control parameter requirement; and
in which the determining further comprises determining the cell-specific power control parameter based at least in part on the neighbor base station power control parameter and/or the serving base station power control parameter requirement.

5. The method of claim 1, further comprising:
receiving a measurement of a UE path loss between a served UE and the neighbor base station; and
determining a cell-specific power control parameter based at least in part on the UE path loss.

6. An apparatus for wireless communications, comprising:
means for determining, by a serving base station, a path loss and/or a distance measurement between the serving base station and a neighbor base station; and
means for setting a UE transmission power based at least in part on the determining.

7. The apparatus of claim 6, further comprising:
means for determining a cell-specific power control parameter based at least in part on the path loss and/or the distance measurement; and
means for assigning a UE transmission rate based at least on a region where a UE is located, the region being within a serving cell.

8. The apparatus of claim 7, in which the means for determining comprises:
means for increasing the cell-specific power control parameter from a baseline value when the path loss and/or the distance measurement is greater than a threshold; and
means for decreasing the cell-specific power control parameter from the baseline value when the path loss and/or the distance measurement is less than the threshold.

9. The apparatus of claim 7, further comprising means for receiving from the neighbor base station a neighbor base station power control parameter and/or a serving base station power control parameter requirement; and
in which the means for determining further comprises means for determining the cell-specific power control parameter based at least in part on the neighbor base station power control parameter and/or the serving base station power control parameter requirement.

10. The apparatus of claim 6, further comprising:
means for receiving a measurement of a UE path loss between a served UE and the neighbor base station; and
means for determining a cell-specific power control parameter based at least in part on the UE path loss.

11. A computer program product for wireless communications, the computer program product comprising:
a non-transitory computer-readable medium having program code recorded thereon, the program code comprising:
program code to determine, by a serving base station, a path loss and/or a distance measurement between the serving base station and a neighbor base station; and
program code to set a UE transmission power based at least in part on the determining.

12. The computer program product of claim 11, further comprising:
program code to determine a cell-specific power control parameter based at least in part on the path loss and/or the distance measurement; and
program code to assign a UE transmission rate based at least on a region where a UE is located, the region being within a serving cell.

13. The computer program product of claim 12, in which the program code to determine comprises:
program code to increase the cell-specific power control parameter from a baseline value when the path loss and/or the distance measurement is greater than a threshold; and
program code to decrease the cell-specific power control parameter from the baseline value when the path loss and/or the distance measurement is less than the threshold.

14. The computer program product of claim 12, further comprising program code to receive from the neighbor base station a neighbor base station power control parameter and/or a serving base station power control parameter requirement; and
in which the program code to determine further comprises program code to determine the cell-specific power control parameter based at least in part on the neighbor base station power control parameter and/or the serving base station power control parameter requirement.

15. The computer program product of claim 11, further comprising:
program code to receive a measurement of a UE path loss between a served UE and the neighbor base station; and
program code to determine a cell-specific power control parameter based at least in part on the UE path loss.

16. An apparatus for wireless communications, comprising:
a memory; and
at least one processor coupled to the memory, the at least one processor being configured:
to determine, by a serving base station, a path loss and/or a distance measurement between the serving base station and a neighbor base station; and
to set a UE transmission power based at least in part on the determining.

17. The apparatus of claim 16, in which the at least one processor is further configured:
to determine a cell-specific power control parameter based at least in part on the path loss and/or the distance measurement; and
to assign a UE transmission rate based at least on a region where a UE is located, the region being within a serving cell.

18. The apparatus of claim 17, in which the at least one processor is further configured:
to increase the cell-specific power control parameter from a baseline value when the path loss and/or the distance measurement is greater than a threshold; and
to decrease the cell-specific power control parameter from the baseline value when the path loss and/or the distance measurement is less than the threshold.

19. The apparatus of claim 17, in which the at least one processor is further configured:
to receive from the neighbor base station a neighbor base station power control parameter and/or a serving base station power control parameter requirement; and
to determine the cell-specific power control parameter based at least in part on the neighbor base station power control parameter and/or the serving base station power control parameter requirement.

20. The apparatus of claim 16, in which the at least one processor is further configured:
to receive a measurement of a UE path loss between a served UE and the neighbor base station; and
to determine a cell-specific power control parameter based at least in part on the UE path loss.
